(19) United States
(12) Patent Application Publication
(10) Pub. No.: US 2004/0184208 A1
(43) Pub. Date: Sep. 23, 2004

(54) Power protecting device for electrical power source and load

(76) Inventor: Daniel Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/390,736

(22) Filed: Mar. 19, 2003

(51) Int. Cl. H02H 3/20

(52) U.S. Cl. 361/90

(57) ABSTRACT

A power protecting device for monitoring and protecting an electrical power source and a load includes a power monitoring circuit for monitoring the power source and sending a signal to a central processing unit. A power fault detecting circuit detects and sends an over voltage signal and an under voltage signal to the central processing unit. A load fault detecting circuit detects and sends an over current signal and an over power signal to the central processing unit. The power protecting device also includes a power-on delay control circuit for delaying the power supply to the load.

### BACKGROUND OF THE INVENTION

1. Field of the Invention

The present invention relates to a power protecting device for electrical power source and load, and more particularly to an electrical power protecting device capable of monitoring and securing the safe operation of the power source and load.

2. Description of the Prior Art

In modern society, power supplying system is a common installation in office and factory. With the power supplying system, a stable and proper power supply to the electric appliances and equipment can be maintained, which is critical for normal operation of electric appliances and equipment. To secure the safe operation, all countries establish various standards for electric appliances. However, since some of the users lack the common knowledge of safe and proper use of electric appliances, and therefore always cause accidents e.g. fire. Fire is usually caused by overloading of power supply and is difficult to be put out. To prevent overloading, regular inspection of power system and electric appliances are necessary. Anyway, it requires experiences and measuring instrument, and is not easy for a user.

Moreover, some of the electric appliances which include compressors e.g. refrigerator, freezer possess unique electric characteristics. When these electric appliances are stopped from operation due to e.g. power failure, they should start operation at least after an appropriate time e.g. three minutes, or else they are likely to be damaged. Hence, it is desired to have a power protecting device which enables the user to monitor the status of power source and electric appliances, and protecting electric appliances from damage due to sudden recovery of power.

### SUMMARY OF THE INVENTION

Consequently, it is a primary object of the present invention to provide a power protecting device for monitoring the electrical power source and load and securing the safety of operation.

Another object of the present invention is to provide a power protecting device with a display unit capable of displaying relevant electrical parameters of the power source and the electric appliances coupled to the power source, The power protecting device is capable of protecting the electric appliances by cutting the power supply at abnormal condition like over current, over voltage, under voltage, over power and so on.

A further object of the present invention is to provide a power protecting device which includes a power-on delay control circuit capable of delaying the power supply to electric appliances that possess unique load characteristics for an appropriate time. By this means, the electric appliances are protected from damage of unexpected power recovery after power failure.

A still further object of the present invention is to provide a power protecting device in the form of an adapter which can be plugged to the socket on wall. Thereby, user can inspect the status of power source easily from the display.

### BRIEF DESCRIPTION OF THE DRAWINGS

The present invention can be best understood through the following description and accompanying drawings, wherein:

FIG. 1 is a functional block diagram of the power protecting device in accordance with the present invention;

FIG. 2 is a control circuit diagram of the power monitoring circuit of FIG. 1;

FIG. 3 is a control circuit diagram of the power fault detecting circuit and load fault detecting circuit of FIG. 1; and

FIG. 4 is a control circuit diagram of the power-on delay control circuit of FIG. 1.

### DETAILED DESCRIPTION OF THE PREFERRED EMBODIMENTS

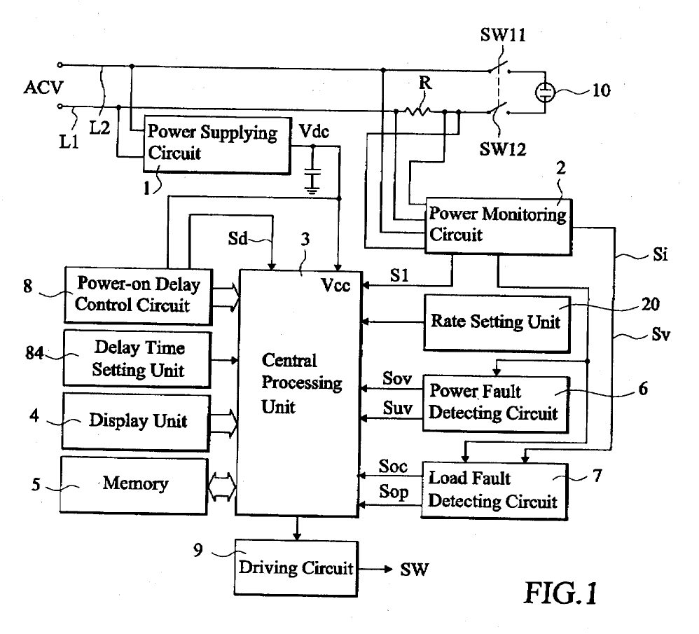

With reference to the drawings and in particular to FIG. 1 which is a functional block diagram of the present invention. Two power lines L1, L2 of an AC power source ACV are respectively connected to a socket 10 via two switches SW11, SW12 for supplying electrical power to an electrical load connected to the socket 10.

As shown in FIG. 1, a power supplying circuit 1 is connected across the power lines L1 and L2 and is used to convert the AC power source ACV into a DC power source Vdc as a working power source for a central processing unit (CPU) 3 and other control circuits of the present invention.

A power monitoring circuit 2 monitors the power supplying status of the power source ACV and then sends a power status signal S1 to the central processing unit 3. Various electrical parameters indicating the status of power source ACV, such as voltage value, current value, power value, time, kilowatt-hour, electricity charge and so on, can be displayed on a display unit 4 coupled to the central processing unit 3. Further, user can set the electricity rate to a rate setting unit 20 for calculation of electricity charge. All the electrical parameters are saved in a memory 5.

The present invention also includes a power fault detecting circuit 6 capable to detect if the power source ACV is normal. A voltage status signal Sv indicating the voltage value of the power source ACV is sent from the power monitoring circuit 2 to the power fault detecting circuit 6 which sends out signals to the central processing unit 3 if power supply is abnormal. For example, when the voltage value of the power source ACV is higher than a predetermined over voltage value, an over voltage signal Sov is sent to the central processing unit 3, When the voltage value of the power source ACV is lower than a predetermined under voltage value, an under voltage signal Suv is sent to the central processing unit 3.

Further, a load fault detecting circuit 7 is capable to detect if load current and voltage are normal. A current status signal Si indicating the current value of a load connected to the socket 10 is sent from the power monitoring circuit 2 to the load fault detecting circuit 7 which sends out signals to the central processing unit 3 if load current and/or voltage is extraordinary. For example, when the load current value of the load is higher than a predetermined over current value, an over current signal Soc is sent to the central processing unit 3. When the power value of the load is higher than a predetermined over power value, an over power signal Sop is sent to the central processing unit 3.

The present invention also includes a power-on delay control circuit 8 capable of delaying the supply of power to the load. Some electric appliances that comprise compressors e.g. refrigerator, freezer, air-conditioner and so on have unique load characteristics. They are likely to be damaged if operation is stopped by some reasons e.g. power failure or power cut off and then restarted within a short time e.g. three minutes. To protect the electric appliances from damage of abrupt power recovery, two switches SW11 and SW12 respectively connecting to the power lines L2 and L1 are controlled to turn on/off respectively by a delay control signal Sd from the power-on delay control circuit 8 and a switch control signal SW from a driving circuit 9 controllable by the central processing unit 3. Thereby, when power source is recovered, power is re-supplied to the electric appliances at least after a predetermined delay time e.g. three minutes counting from the time of power termination.

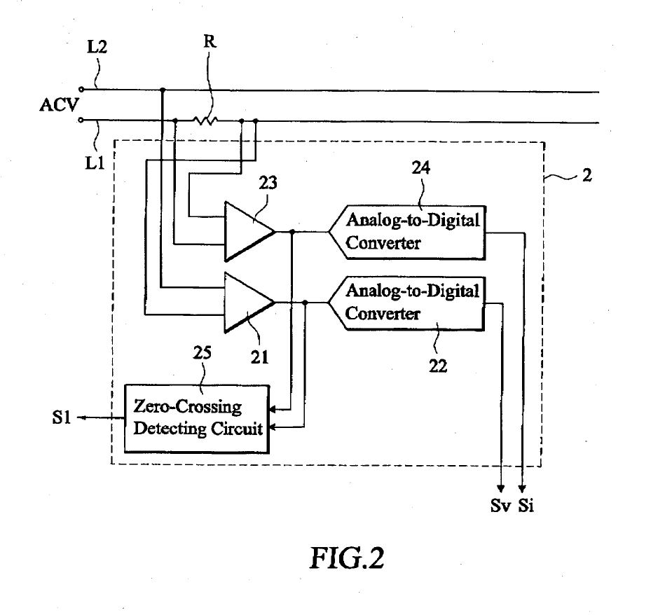

With reference to FIG. 2, the power monitoring circuit 2 of the present invention as shown in FIG. 1 includes a voltage amplifier 21. The two input ends of the voltage amplifier 21 are electrically connected in parallel to the power lines L1, L2 to detect the voltage value of power source ACV. An analog voltage value generated by the voltage amplifier 21 is converted to a digital voltage status signal Sv by an analog-to-digital converter 22.

The power monitoring circuit 2 also includes a current amplifier 23 and a resistor R. The resistor R is serially connected with one of the power lines such as L1, and two input ends of the current amplifier 23 are electrically connected across the resistor R for detecting the current value passing through the load. An analog-to-digital converter 24 is used to convert an analog current value generated by the current amplifier 23 into a digital current status signal Si.

A zero-crossing detecting circuit 25 is capable of detecting the zero-crossing point of the voltage of the power source ACV. Two input ends of the zero-crossing detecting circuit 25 are respectively connected to the output ends of the voltage amplifier 21 and the current amplifier 23. Each time the value of the alternating current voltage is zero, the zero-crossing detecting circuit 25 will send an output pulse power status signal S1 at its output end to the central processing unit 3. Accordingly, the central processing unit 3 determines if the power source is normal.

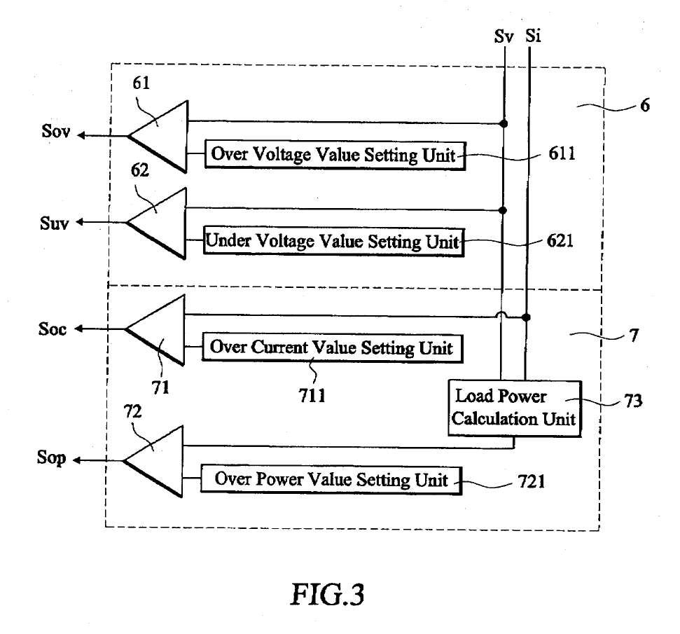

As shown in FIG. 3 which is a control circuit diagram of the power fault detecting circuit 6 and load fault detecting circuit 7 of FIG. 1. The power fault detecting circuit 6 comprises an over voltage detecting circuit 61. One input end of the over voltage detecting circuit 61 is electrically connected to the power monitoring circuit 2 for receiving the digital voltage status signal Sv therefrom. The other input end of the over voltage detecting circuit 61 is electrically connected to an over voltage value setting unit 611 for setting of predetermined over voltage value. When the voltage of power source ACV is larger than the predetermined over voltage value, the over voltage detecting circuit 61 sends an over voltage signal Sov to the central processing unit 3.

The power fault detecting circuit 6 also comprises an under voltage detecting circuit 62. One input end of the under voltage detecting circuit 62 is electrically connected to the power monitoring circuit 2 for receiving the digital voltage signal Sv therefrom. The other input end of the under voltage detecting circuit 62 is electrically connected an under voltage value setting unit 621 for setting of predetermined under voltage value. When the voltage of power source ACV is smaller than the predetermined under voltage value, the under voltage detecting circuit 62 sends an under voltage signal Suv to the central processing unit 3.

The load fault detecting circuit 7 comprises an over current detecting circuit 71. One input end of the over current detecting circuit 71 is electrically connected to the power monitoring circuit 2 for receiving the digital current status signal Si therefrom. The other end of the over current detecting circuit 71 is electrically connected to an over current value setting unit 711 for setting of predetermined over current value. When the current passing through the resistor R from the power source ACV to the load is larger than the predetermined over current value, the over current detecting circuit 71 sends an over current signal Soc to the central processing unit 3.

The load fault detecting circuit 7 also comprises an over power detecting circuit 72. One input end of the over power detecting circuit 72 is electrically connected to a load power calculation unit 73 for getting a load power consumption value obtained by multiplying the voltage status signal Sv and the current status signal Si. The other input end of the over power detecting circuit 72 is electrically connected an over power value setting unit 721 for setting of predetermined over power value. When the load power calculated by the load power calculation unit 73 is larger than the predetermined over power value, the over power detecting amplifier 72 sends an over power signal Sop to the central processing unit 3.

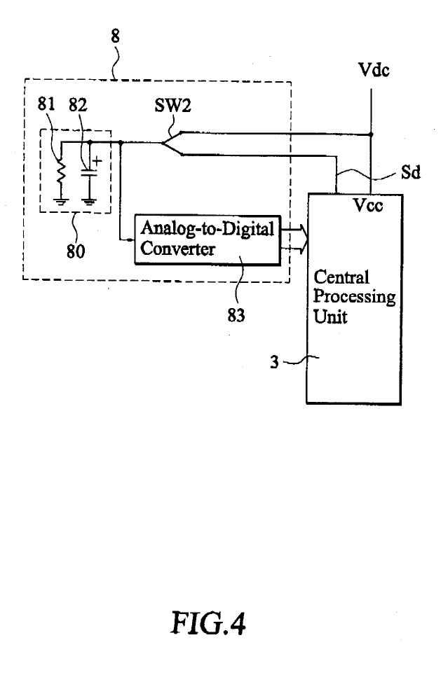

With reference to FIG. 4 which shows a control circuit diagram of the power-on delay control circuit of FIG. 1, the power-on delay control circuit 8 includes a timing circuit 80 comprising a resistor 81 and a capacitor 82 connected with the resistor 81 is parallel. A switch SW2 is connected between the timing circuit 80 and the power supplying circuit 1. When the DC power source Vdc is normal (indicating the power source ACV is normal), the timing circuit 80 is charged. The voltage value of the timing circuit 80 is converted to a digital voltage signal by an analog-to-digital converter 83 and sent to the central processing unit 3.

When the DC power source Vdc is cut off, the capacitor 82 and resistor 81 of the timing circuit 80 forms a discharging circuit. The discharging circuit starts time counting and sends a power-on delay control signal Sd to the central processing unit 3. On receiving the power-on delay control signal Sd, the central processing unit 3 sends a switch control signal SW to control the switches SW11, SW12. If the power source is recovered within the time period, power supply to the load is still disconnected. After the time period and under the control the central processing unit, the power supply to the load is resumed. If the power source is recovered after the time period, the central processing unit 3 will restart the load immediately without delay. The power-on delay control circuit 8 is also triggered to function when there is abnormal power supply like over voltage, under voltage, over current, over power and so on. Again, when the power supply is returned to normal, the central processing unit 3 will restart the load only if the time period is past.

The central processing unit 3 also comprises a delay time setting unit 84, to which the delay time of power-on delay control circuit 8 can be set by the user according to load characteristic or requirement.

Practically, after the delay time counting triggered by abnormal power supply e.g. over voltage or under voltage, the load is restored to operate. Before restarting the load, the central processing unit 3 may check the power source to assure if abnormality still exists. The central processing unit 3 will restart the load only if normal condition is restored and the delay time is over.

The present invention can be made and used in the form of an adapter, such that it can be plugged to the socket on wall. Thereby, the status of the power source and load can be displayed on the display. In case of abnormal condition, electric appliances can be protected from damage.

It should be noted that the above description and accompanying drawings are only used to illustrate one embodiment of the present invention, not intended to limit the scope thereof. Any modification of the embodiment should fall within the scope of the present invention.

I claim:

1. A power protecting device for an AC power source connected with a load, comprising:
a central processing unit;
a power monitoring circuit coupled to the AC power source and the load for monitoring the AC power source and the load, and thereby generating a power status signal to the central processing unit, a voltage status signal, and a current status signal;
a power fault detecting circuit for generating an over voltage signal and an under voltage signal to the central processing unit by detecting the voltage status signal generated by the power monitoring circuit; and
a load fault detecting circuit for generating an over current signal and an over power signal to the central processing unit by detecting the current status signal generated by the power monitoring circuit.

2. The power protecting device as claimed in claim 1, wherein the power fault detecting circuit comprises:
an over voltage detecting circuit for generating the over voltage signal by comparing the voltage status signal with a predetermined over voltage value; and
an under voltage detecting circuit for generating the under voltage signal by comparing the voltage status signal with a predetermined under voltage value.

3. The power protecting device as claimed in claim 1, wherein the load fault detecting circuit comprises:
an over current detecting circuit for generating the over current signal by comparing the current status signal with a predetermined over current value; and
an over power detecting circuit for generating the over power signal by comparing a load power consumption value obtained by multiplying the voltage status signal and the current status signal with a predetermined over power value.

4. The power protecting device as claimed in claim 1, further comprising a display unit coupled to the central processing unit for displaying electrical parameters comprising a voltage value, a current value, a power value, a time, a kilowatt-hour, and an electricity charge.

5. The power protecting device as claimed in claim 1 further comprising a rate setting unit coupled to the central processing unit for setting an electricity rate.

6. The power protecting device as claimed in claim 1, wherein the power protecting device is in a form of an adapter.

7. The power protecting device as claimed in claim 1, further comprising a power-on delay control circuit coupled to the central processing unit for generating a delay control signal to the central processing unit.

8. The power protecting device as claimed in claim 7, wherein the power-on delay control circuit comprises:
a timing circuit; and
a switch connected in series between the timing circuit and a DC power source;
wherein when the DC power source is normal, the timing circuit is charged to a charged voltage value, and when the DC power source is abnormal, a power-on delay control signal is sent to the central processing unit for delaying the power supply to the load.

9. The power protecting device as claimed in claim 8, wherein the charged voltage value of the timing circuit is further converted to a digital voltage signal by an analog-to-digital converter and sent to the central processing unit.

10. The power protecting device as claimed in claim 8, wherein the timing circuit comprises a resistor and a capacitor connected in parallel.
